(19) United States
(12) Patent Application Publication
(10) Pub. No.: US 2008/0303674 A1
(43) Pub. Date: Dec. 11, 2008

(54) Holder with Wireless Ic Tag and Tire with Wireless Ic Tag

(75) Inventors: Yuuki Hara, Tokyo (JP); Takashi Kikuchi, Tokyo (JP); Jun Goshima, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Bridgestone Corporation, Chuo-ku, Tokyo (JP)

(21) Appl. No.: 11/547,161

(22) PCT Filed: Mar. 31, 2005
(86) PCT No.: PCT/JP05/06287

§ 371 Date: Jun. 29, 2007

(30) Foreign Application Priority Data
Mar. 31, 2004 (JP) 2004-106734

(51) Int. Cl. G08B 13/22

(52) U.S. Cl. 340/572.8

(57) ABSTRACT

Communication between a scanner and a wireless IC tag is performed with certainty. An installation hole is formed in the side surface of a tire and a holder with wireless IC tag 10 housing a wireless IC tag 18 is inserted into this installation hole. The holder with wireless IC tag 10 can open and close. It is opened, the wireless IC tag 18 is housed in a pocket 20, the holder with wireless IC tag 10 is closed and inserted into the installation hole. The holder with wireless IC tag 10 housing the wireless IC tag 18 is inserted into the outer surface of the tire so a scanner can be brought close to the wireless IC tag 18, which can reliably communicate with the scanner. Further, the holder with wireless IC tag 10 is installed to the tire after vulcanization so there does not cause damage to the wireless IC tag 18 due to heat and the like.

### TECHNICAL BACKGROUND

The present invention relates to a holder with wireless IC tag used for installing a wireless IC tag to a target object of installation, and also relates to a tire with wireless IC tag.

### BACKGROUND OF THE ART

There are examples where barcodes are installed to goods in order to perform identification of the goods.

Also, in recent years, various types of miniature wireless IC tags used in identifying objects have been proposed, some in which data such as a unique identification code is recorded, and those that use radio waves and have the ability to send and receive data to and from a management system.

The amount of data stored with this type of wireless IC tag is incomparably more than when compared to a barcode and, unlike a barcode that is scanned with a laser, it can be installed inside the goods.

Wireless IC tags generally comprise an IC chip and an antenna, and a wide range of forms have been proposed.

For the data inside the chip, codes such as product codes used up until now with barcodes and individual characteristic manufacturing numbers are included therein.

Unlike with barcodes, wireless IC tags can be simultaneously scanned regardless of the direction they are facing as long as they are in a range where radio waves can reach them, so the labor involved in scanning can be curtailed.

Meanwhile, barcodes for use in identification are also used in vehicle tires, and the use of wireless IC tags in place of barcodes is conceivable.

There are conventional methods for installing an IC chip in a tire, for example, the methods recited in Patent Publications 1-3.

### Patent Publication 1: Japanese Patent Application Laid-open No. 11-278021

### Patent Publication 2: Japanese Patent Application Laid-open No. 2002-205516

### Patent Publication 3: Japanese Patent Application Laid-open No. 2002-502765

### DISCLOSURE OF THE INVENTION

### Subjects to be Solved by the Invention

Despite the above, with the installation method of Japanese Patent Application Laid-open No. 11-278021, the tag is installed to the inner lining of a pneumatic tire so it cannot be installed after assembly of the rim. Also, when using a miniature wireless IC tag, the radio wave output is small and the radio waves cannot pass through the thick rubber layers (and further, the metal belts in the treads) of large-sized tires such as those used in construction vehicles.

With the installation method of Japanese Patent Application Laid-open No. 2002-205516, the transponder is placed in a metal mold for use with vulcanization and, after that, inserted into a non-vulcanized tire after which vulcanization is performed, so the IC is heated during vulcanization and damaged.

Especially with the large-sized tires used in construction vehicles, vulcanization is performed at 100° C. or higher at 10 atmospheres of pressure or more for four hours or more so the chances of damaging the IC are extremely high. There is also the problem in that when the IC is damaged after vulcanization, it cannot be replaced.

Furthermore, with the installation method of Japanese Patent Application Laid-open No. 2002-502765, an electronic package is installed to the inner surface of a pneumatic tire so it cannot be installed after rim assembly. Also, when using a miniature wireless IC tag, the radio wave output is small and the radio waves cannot pass through the thick rubber layers of large-sized tires such as those used in construction vehicles.

A method can also be considered where the wireless IC tag is stuck to a rubber sheet, which is stuck to the tire surface using adhesive, however, there are problems in that the job of ground processing and the like for the tire surface is complicated and it is also easy for the rubber sheet to peel off.

The present invention was made in order to solve the above, and to propose a holder with wireless IC tag with which communication between a scanner and a wireless IC tag can be reliably performed; and to propose a tire with a wireless IC tag.

### Measures for Solving the Subjects

The invention according to claim 1 is a holder with wireless IC tag for installing a wireless tag to a target object of installation comprises a main body case that is insertable into the target object of installation itself or a hole formed in the target object of installation, and a housing portion provided in the main body case that houses the wireless IC tag.

Next, the function of the holder with wireless IC tag of claim 1 will be explained.

The wireless IC tag can be housed in the housing portion of the holder with wireless IC tag.

The holder housing the IC tag can be installed to a target object of installation by being forcefully inserted into the surface of a component comprising the target object of installation (by opening a hole in the component with the holder with wireless IC tag itself), or inserted into a hole formed in the target object of installation.

Note that when the wireless IC tag is directly buried into and provided at the rubber portion of the tire, attenuation of the radio waves due to the rubber increases. Nonetheless, by forming the main body case from a material besides rubber such as a synthetic resin or metal and the like, attenuation of the radio waves emitted to the exterior can be suppressed. For example, by forming the main body case from a synthetic resin through which it is easier than rubber for radio waves to pass, radio waves can be emitted efficiently to the exterior. Further, when forming the main body case from a metal, these can also be emitted to the exterior directly from the main body case (i.e., the main body case becomes a substitute for an antenna).

The invention according to claim 2 is, in the holder with wireless IC tag recited in claim 1, a tapered portion that becomes acute along a direction towards the tip thereof is integrally formed with the main body case.

Next, the function of the holder with wireless IC tag recited in claim 2 will be explained.

The tapered portion that becomes acute along a direction towards the tip thereof is formed with the main body case. Accordingly, by pointing the tapered portion at the target object of installation, it becomes easy to insert it into the surface of the component comprising the target object of installation or to insert it into a hole formed in the target object of installation.

The invention according to claim 3 is, with the holder with wireless IC tag recited in claim 2, the diameter of the main body case is smaller than the part of the tapered portion with the largest diameter.

Next, the function of the holder with wireless IC tag recited in claim 3 will be explained.

The main body case is made to have a diameter smaller than the part of the tapered portion having the largest diameter. Accordingly, with the holder with wireless IC tag inserted into the target object of installation from the tapered portion side, the part with the greatest diameter catches when the holder tries to pop out of the target object of installation so popping out of the holder from the target object of installation can be prevented.

The invention according to claim 4 is, with the holder with wireless IC tag recited in claim 1 or claim 2, a small diameter portion is formed at the main body case at the side opposite to the side with the tip of the tapered portion and made to have a diameter smaller than the part of the tapered portion with the largest diameter, and in that a step portion is formed at the boundary between the tapered portion and the small diameter portion.

Next, the function of the holder with wireless IC tag recited in claim 4 will be explained.

A small diameter portion is formed at the main body case at the side opposite to the side with the tip of the tapered portion and made to have a diameter smaller than the part of the tapered portion with the largest diameter, and a step portion is formed at the boundary between the tapered portion and the small diameter portion. Accordingly, when the holder with wireless IC tag inserted into the target object of installation tries to pop out, the step portion (i.e., the edge of the part of the tapered portion with the largest diameter) catches on the target object of installation so popping out of the holder from the target object of installation can be prevented.

The invention according to claim 5 is, in the holder with wireless IC tag recited in any one of claim 1 to claim 4, the largest diameter of the tapered portion is larger than the diameter of the hole formed in the target object of installation.

Next, the function of the holder with wireless IC tag recited in claim 5 will be explained.

The holder with wireless IC tag recited in claim 5 has the tapered portion with the largest diameter larger than the diameter of the hole formed in the target object of installation. Accordingly, it is easy to insert and after insertion, the portion with the largest diameter catches on the hole so popping out of the holder can be prevented.

The invention according to claim 6 is, in the holder with wireless IC tag recited in any one of claim 1 to claim 5, the main body case is provided with a pair of components and a connecting component that connects the pair of components and which allows opening and closing of one component and the other component, wherein the housing portion is formed in at least one of the pair of components and is an indented portion that is sealed when the one component and the other component are closed.

Next, the function of the holder with wireless IC tag recited in claim 6 will be explained.

After the main body case is opened and the wireless IC tag is placed in the indented portion, the main body case is closed whereby the wireless IC tag is housed in a sealed state within the main body case.

Note that the main body case is inserted into and provided in a buried manner in the installation object so it does not open.

A tire according to claim 7 has the holder with wireless IC tag in which a wireless IC tag is housed according to any one of claim 1 to claim 6, and the holder is inserted into an outer surface of the tire.

Next, the function of the tire recited in claim 7 will be explained.

The holder with wireless IC tag in which a wireless IC tag is housed is inserted into an outer surface of the tire. Accordingly, a scanner can be brought close to the wireless IC tag and it can communicate with the scanner reliably.

Further, the holder with wireless IC tag is installed in the tire after vulcanization so damage is not caused to the wireless IC tag due to heat and the like.

The tire according to claim 8 has the holder with wireless IC tag in which a wireless IC tag is housed recited in any one of claim 1 to claim 6, and the holder is inserted into an installation hole formed in the outer surface of the tire.

Next, the function of the tire recited in claim 8 will be explained.

The holder with wireless IC tag in which the wireless IC tag is housed is inserted into an installation hole formed in the outer surface of the tire. Accordingly, a scanner can be brought close to the wireless IC tag and it can communicate with the scanner reliably.

Further, the holder with wireless IC tag is installed in the tire after vulcanization so damage is not caused to the wireless IC tag due to heat and the like.

Also, it is configured that the holder with wireless IC tag is installed in the hole, so installation of the holder is easy.

The invention according to claim 9 is, in the tire recited in claim 8, the diameter of an entrance side of the installation hole is smaller than that of an inner side of the installation hole.

Next, the function of the tire recited in claim 9 will be explained.

The diameter of the entrance side of the installation hole is smaller than that of the inner side of the installation hole so a holder with wireless IC tag inserted towards the interior of the installation hole catches on the vicinity of the entrance so popping out of the holder from the installation hole can be prevented.

The invention according to claim 10 is, in the tire recited in any one of claim 7 to claim 9, the holder with wireless IC tag housing the wireless IC tag is inserted into both widthwise direction side surfaces of the tire.

Next, the function of the tire recited in claim 10 will be explained.

At the side surface facing the interior side of the vehicle, there are cases where the vehicle body gets in the way whereby a scanner cannot be brought close to the wireless IC tag. Further, there are instances where the side having the wireless IC tag is faced towards the inner side of the vehicle due to rotation.

Accordingly, it is preferable to install the holder with wireless IC tag to the side surfaces at both sides in the tire widthwise direction so that, no matter how the tire is installed, a wireless IC tag is arranged at a side surface that faces the exterior side of the vehicle.

The invention according to claim 11 is, in the tire recited in any one of claim 7 to claim 10, the holder with wireless IC tag is arranged at two or more places on the side surface of the tire with intervals spaced therebetween in the circumferential direction of the tire.

Next, the function of the tire recited in claim 11 will be explained.

In the case of a large-sized tire used with construction vehicles and the like, there are tires whose diameters are two or more meters.

In the case of this type of large-sized tire, if the holder with wireless IC tag is installed at one place only on the side surface of the tire, the holder with wireless IC tag can be positioned at a place whose height is two or more meters from the road surface, and there are cases where it is difficult for an operator standing on the road surface to bring a scanner close to the wireless IC tag.

Accordingly, in the case of this type of large-sized tire, if the holder is arranged at two or more places on the side surface of the tire with intervals spaced therebetween in the circumferential direction of the tire, even if one holder is at a high position, the other one becomes arranged in a low position so it becomes easy to bring a scanner close to the wireless IC tag.

The invention according to claim 12 is, in the tire recited in claim 11, the holders with wireless IC tag are arranged so that, during one rotation of the tire, at least one of the holder with wireless IC tag is positioned less than two meters from the road surface.

Next, the function of the tire recited in claim 12 will be explained.

If multiple holders with wireless IC tags are dispersed and arranged in the circumferential direction so that at least one holder with wireless IC tag is positioned less than two meters from the road surface, it becomes easy for an operator standing on the road surface to bring a scanner close to the wireless IC tag.

The invention according to claim 13 is, in a tire recited in any one claim of claim 7 to claim 12, at least the color of a portion of the main body case exposed at the tire surface differs from the color of the tire.

Next, the function of the tire recited in claim 13 will be explained.

When communicating with a wireless IC tag with a scanner using radio waves and electromagnetic waves, it is necessary to bring the scanner close to a certain degree to the wireless IC tag because the output at the miniature wireless IC tag is small.

In such instances, if the color of the holder with wireless IC tag is the same as that of the tire, it becomes difficult to find the holder with wireless IC tag.

Accordingly, by making at least the color of a portion of the main body case exposed at the tire surface differ from the color of the tire, it becomes easy to find the holder with wireless IC tag.

### EFFECTS OF THE INVENTION

As explained above, the holder with wireless IC tag of the present invention is reliable in its retention of the wireless IC tag and can be provided buried into the outer surface of a tire product in which vulcanization has been completed. Accordingly, communication with a scanner can be performed reliably.

As explained above, the tire of the present invention uses the holder with wireless IC tag in order to bury the wireless IC tag into its outer surface. Accordingly, communication with a scanner can be performed reliably.

### BRIEF DESCRIPTION OF THE DRAWINGS

FIG. 1A is a perspective drawing showing a holder with a wireless IC tag according to a first embodiment in a state where the holder is open;

FIG. 1B is a perspective drawing showing a holder with a wireless IC tag in a state where the holder is closed;

FIG. 2A is a cross-sectional drawing of the vicinity of the bead of a tire;

FIG. 2B is an enlarged cross-sectional drawing of the vicinity of an installation hole of a tire;

FIG. 2C is an enlarged cross-sectional drawing of the vicinity of the installation hole of a tire showing a state where the holder with the wireless IC tag is inserted therein;

FIG. 2D is an enlarged cross-sectional drawing of the vicinity of the installation hole of a tire showing a state where the holder with the wireless IC tag is inserted therein;

FIG. 3 is a side surface drawing of a tire;

FIG. 4A is a cross-sectional drawing of the holder with a wireless IC tag according to a second embodiment;

FIG. 4B is an enlarged cross-sectional drawing of the vicinity of an installation hole of a tire; and

FIG. 4C is an enlarged cross-sectional drawing of the vicinity of the installation hole of a tire showing a state where the holder with the wireless IC tag is inserted therein.

### BEST MODES FOR PRACTICING THE INVENTION

### First Embodiment

Hereafter, an example of an embodiment of the present invention will be explained in detail while referring to the drawings.

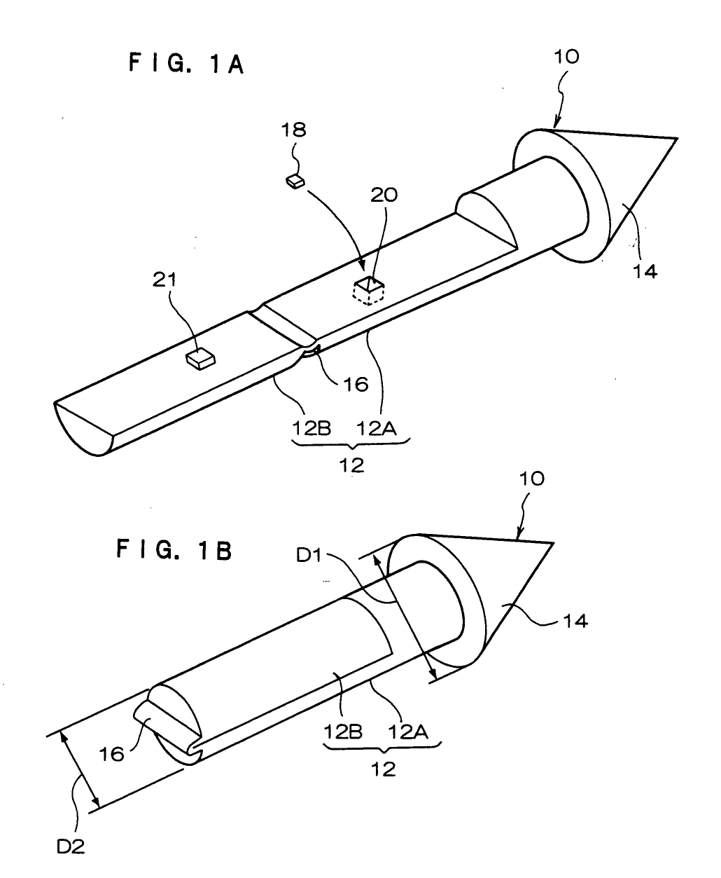

The holder with wireless IC tag 10 according to the first embodiment of the present invention will be explained while following FIGS. 1A-3.

As shown in FIGS. 1A and 1B, the holder with wireless IC tag 10 of the present embodiment is formed from a synthetic resin such as polypropylene, and is provided with a cylindrical main body case 12 and a cone-shaped inserted portion 14.

Note that the outer diameter D1 of the inserted portion 14 (i.e., its largest diameter) is formed to be larger than the outer diameter D2 of the main body case 12.

The main body case 12 can be split in two along the axial line and consists of a first case piece 12A formed integrally at one end with the inserted portion 14 and a second case piece 12B that becomes opposite the first case piece 12A.

The end portions of both the first case piece 12A and second case piece 12B at the opposite side from the inserted portion 14 are connected to each other with an elastically deformable thin connecting portion 16, and these can pivot with each other centered on the connecting portion 16.

An indented pocket 20 that houses a wireless IC tag 18 is formed in the first case piece 12A in the planar surface portion facing the second case piece 12B.

On the other side, a protrusion 21 that fits into the pocket 20 is formed in the second case piece 12B in the planar surface portion facing the first case piece 12A.

By closing the first case piece 12A and second case piece 12B, the protrusion 21 fits into the pocket 20 so that it becomes sealed.

Note that for the wireless IC tag 18, examples of devices that can be used include the μ-chip (product name: non-contact IC chip with internal antenna, produced by Hitachi, Ltd.), the coil-on-chip RFID (produced by Hitachi Maxell, Ltd.), the sesame seed chip and the like, however, as long as the device is a type that can exchange communication with non contact, it is not limited to these.

### (Function)

Next, the process for installing the wireless IC tag to the tire using the holder with wireless IC tag 10 of the present embodiment will be explained.

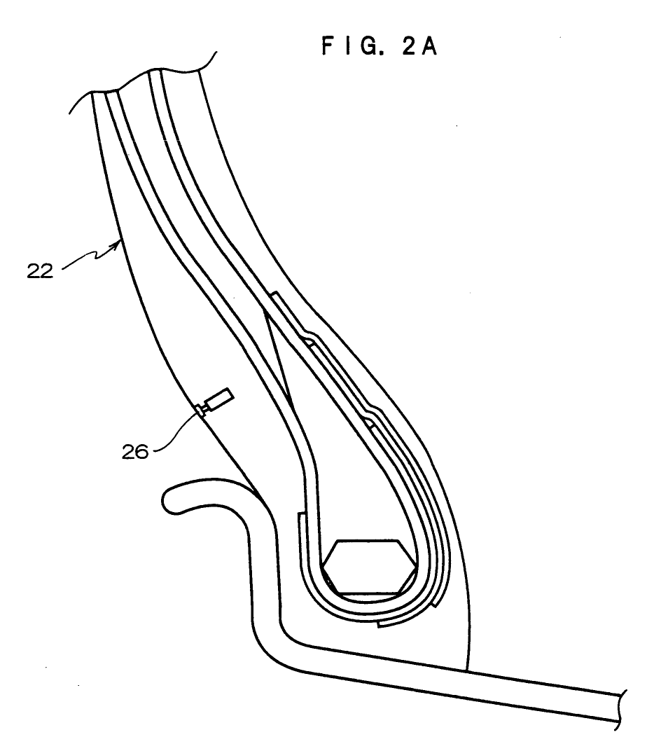

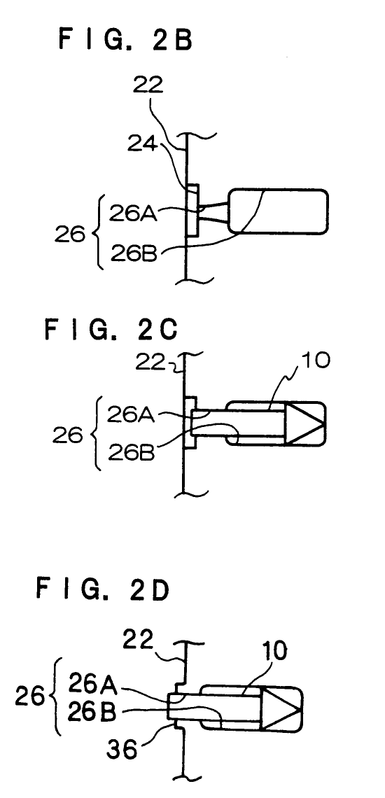

As shown in FIGS. 2A-2D, with the present embodiment, an indentation 24 is formed in the side surface of the tire 22 that is on the outer side of the vehicle at the time of installation of the tire 22 to the vehicle (at the side portion or bead portion). An installation hole 26 into which the holder with wireless IC tag 10 is inserted is formed in the center of the indentation 24 in advance.

Note that with relation to the rotation, when it is unclear as to which side surface of the tire 22 will be on the outer side of the vehicle at the time of installation to the vehicle, it is preferable to form the installation hole 26 in the surfaces of both sides.

The diameter of the installation hole 26 differs at the entrance side and the inner side. The entrance side is a small diameter hole 26A and the inner side is a large diameter hole 26B of a diameter larger than that of the small diameter hole 26A.

Note that the diameter of the small diameter hole 26A is set to be the same diameter as the outer diameter of the main body case 12 of the holder with wireless IC tag 10, or a diameter slightly smaller than that. The diameter of the large diameter hole 26B is set to be the same diameter as the outer diameter of the inserted portion 14 or a diameter slightly smaller than that.

First, as shown in FIG. 1A, the holder with wireless IC tag 10 is opened, the wireless IC tag 18 is inserted in the pocket 20 of the first case piece 12A and, as shown in FIG. 1B, the holder with wireless IC tag 10 is closed.

Due to this, the wireless IC tag 18 is housed in the interior of the holder with wireless IC tag 10 in a sealed state.

Next, the inserted portion 14 of the holder with wireless IC tag 10 is matched with the installation hole 26 formed in the side surface of the tire 22 and inserted into the interior of the installation hole 26.

When the inserted portion 14 passes through the small diameter hole 26A of the installation hole 26, it makes the surrounding rubber elastically deform and passes through the small diameter hole 26A while spreading it. Then, once passage of the inserted portion 14 is complete, the small diameter hole 26A returns to its original diameter.

Due to this, installation of the holder with wireless IC tag 10 to the installation hole 26 becomes complete.

Note that the inserted portion 14 is housed in the large diameter hole 26B and that the main body case 12 is in a state where it is inserted into the small diameter hole 26A.

With the present embodiment, the diameter of the inserted portion 14 is set to be larger than the diameter of the small diameter hole 26A, so the inserted portion 14 catches on the edge of the small diameter hole 26A, and the holder with wireless IC tag 10 popping out of the installation hole 26 due to vibration and the like can be prevented.

In this manner, the holder with wireless IC tag 10 of the present embodiment can easily house the wireless IC tag 18 and can be easily installed to the tire 22.

With this tire 22, the holder with wireless IC tag 10 housing the wireless IC tag 18 is inserted into the outer surface. Accordingly, a scanner can be brought close to the wireless IC tag 18, which can then reliably communicate with the scanner.

Further, the holder with wireless IC tag 10 is installed in the tire 22, which became a manufactured good after vulcanization, so no damage is imparted to the wireless IC tag 18 due to heat and the like.

Also, the holder with wireless IC tag 10 is installed in the side surface of the tire that faces the outer side of the vehicle when installed to the vehicle, so the body of the vehicle does not get in the way and a scanner can be brought close to the wireless IC tag 18.

Note that the color of the holder with wireless IC tag 10 can be any color, however, in order to make it easy to find the holder with wireless IC tag 10, it is preferable that it be made a color that differs from that of the tire 22 (black), for example, white, grey, yellow, red, green, etc.

Also, in order to make the holder with wireless IC tag 10 easy to find from the outside, it is preferable to make it protrude slightly from the outer surface of the tire or made to be level with the outer surface of the tire, as not shown in the drawings.

Note that in the above-described embodiment, the indentation 24 is formed in the side surface of the tire 22 and the installation hole 26, into which the holder with wireless IC tag 10 is inserted, is formed in the center of the indentation 24. However, as shown in FIG. 2D, a protruding boss 36 can be formed in the side surface and the installation hole 26 can be formed in the center of this boss 36. Also in this case, where the installation hole 26 is formed in the boss 36, the holder with wireless IC tag 10 can be made to protrude slightly from the peak of the boss 36, or, as is not shown in the drawings, made to be a level surface with the peak of the boss 36.

Further, when the size of the tire 22 is large like when used in a construction vehicle, it is preferable to install two holders with wireless IC tags 10 in the tire side surface at an even interval (i.e., a 180° interval) in the circumferential direction, preferably three or more and even more preferably four or more.

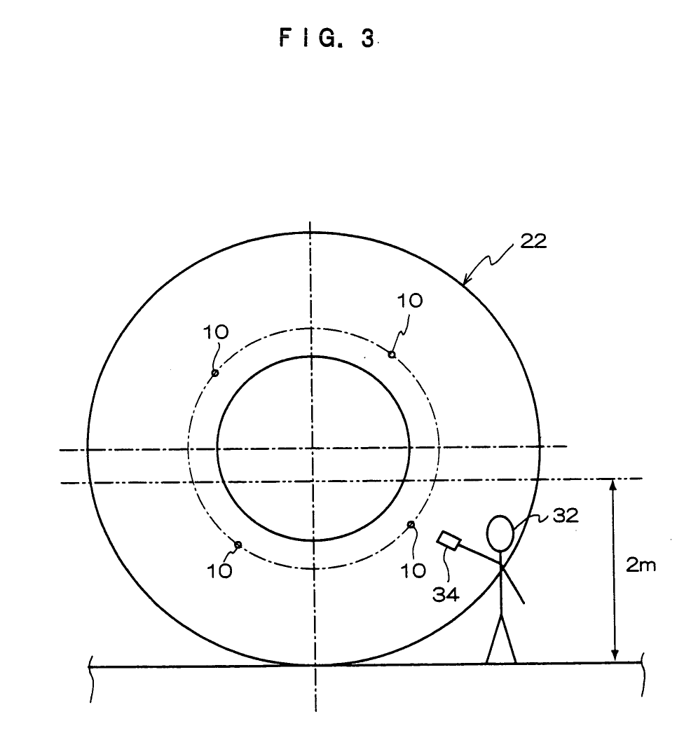

Also, as shown in FIG. 3, it is preferable to arrange the holder with wireless IC tag 10 such that, during one rotation of the tire 22, at least one holder is positioned less than two meters from the road surface.

Due to this, even if one holder with wireless IC tag 10 is at a high position, the other holder with wireless IC tag 10 will be arranged at a lower position. It thus becomes easy for an operator 32 standing on the road to bring a scanner 34 close to the wireless IC tag 18.

With the bead portion of a tire used in construction vehicles, the rubber gauge of the ply outer side is 20 mm or more so if the length of the holder with wireless IC tag 10 is, for example, about 10 mm, there are no effects on the tire's performance even if it is inserted into the bead portion.

Further, the installation position for the holder with wireless IC tag 10 is not limited to the bead portion and other areas like the side portion are also suitable.

Note that with medium to small-type tires (e.g., with diameters of 3 m or less), for example, even the upper part of the bead portion is within a range where a laborer standing on the road surface can reach their hand so in this case, the number of holders with wireless IC tags 10 installed can be one per side.

Note that although the holder with wireless IC tag 10 of the present embodiment is formed from a synthetic resin like propylene through which it is easier for radio waves to pass than with rubber, the material can be something else besides a synthetic resin. The holder with wireless IC tag 10 can also be formed from metal and in this case, radio waves can be emitted directly from the holder with wireless IC tag 10. In other words, the holder with the wireless IC tag itself can be made to function as an antenna.

### Second Embodiment

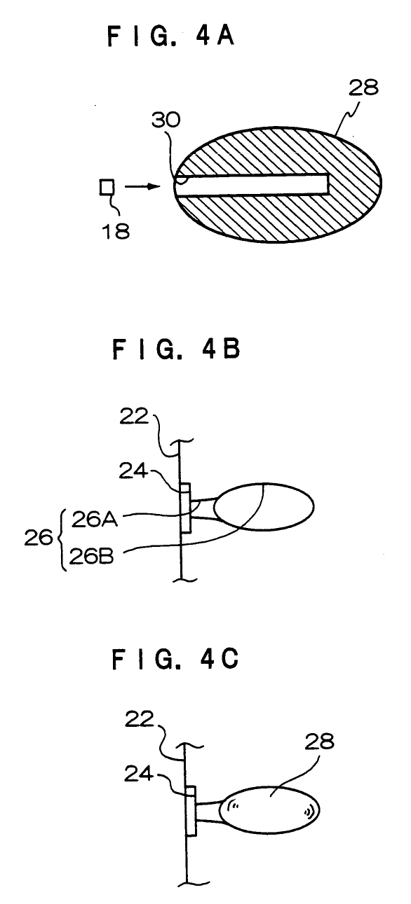

Hereafter, the holder with the wireless IC tag according to the second embodiment of the present invention will be explained while following FIGS. 4A-4C.

A holder with wireless IC tag 28 of the present embodiment has, as shown in FIG. 4A, an elliptical globe shape (i.e., shaped like a rugby ball or an egg, etc.).

A hole 30 is formed in the axial center portion in the holder with wireless IC tag 28.

With the present embodiment, the wireless IC tag 18 is arranged at the bottom of the hole 30, after which the opening portion of the hole 30 is sealed with a sealant or an adhesive. As shown in FIG. 4C, the holder with wireless IC tag 10 that sealed the hole 30 is inserted into the installation hole 26 of the side surface of the tire 22.

Note that, as shown in FIG. 4B, it is preferable that the shape of the installation hole 26 of the tire 22 be made to match that of the holder with wireless IC tag 10.

### Other Embodiments

It should be noted that in the above-described embodiments, examples are shown where the holder with wireless IC tag 10 is installed to the tire, however, the holder with wireless IC tag 10 can be installed to other items besides the tire.

Also, the shape of the holder with wireless IC tag 10 is not limited to the shapes shown in the above embodiments. As long as it is a shape that can be inserted into the target object, it can be any shape.

Further, with the first embodiment, an example is shown where the holder with wireless IC tag 10 is inserted into the installation hole 26 of the tire 22. However, if the holder with wireless IC tag 10 can be forcefully pressed into and provided in an embedded manner in the tire 22, this is also acceptable.

It also is a given that the dimensions of the wireless IC tag 18 and the holders with wireless IC tags 10, 28 are matched and set with the rubber gauge of the tire 22 so as to not reduce tire performance.

Further, the holders with wireless IC tags 10, 28 are preferably buried in the vicinity of specified areas where characters indicating the tire size, maker, etc., numbers or marks are formed in the side surface of the tire 22. Due to this, it becomes easy to find the holders with wireless IC tags 10, 28.

Note that the forms of the holders with wireless IC tags 10, 28 are not limited to the forms shown in the above-described embodiments. Various shapes can be taken as long as it is insertable into the target object of installation itself or a hole formed in the target object of installation. For example, the entire body can also be made to have a screw shape and it can be screwed into the target object of installation with a screwdriver and the like. In this case, the housing portion (e.g., hole, etc.) that houses the wireless IC tag 18 should be formed in a portion of the screw, for example, in a part like the head portion.

### INDUSTRIAL APPLICABILITY

The present invention can be applied to reliably performing communication between a scanner and a wireless IC tag.

### CODE EXPLANATIONS

10: HOLDER WITH WIRELESS IC TAG
12: MAIN BODY CASE
14: INSERTED PORTION (TAPERED PORTION)
16: CONNECTING PORTION (CONNECTING COMPONENT)
18: WIRELESS IC TAG
20: POCKET (INDENTATION)
22: TIRE
26: INSTALLATION HOLE.

1. A holder with wireless IC tag for installing a wireless IC tag to a target object of installation comprising:
a main body case that is insertable into the target object of installation itself or a hole formed in the target object of installation; and
a housing portion, provided in the main body case, that houses the wireless IC tag.

2. The holder with wireless IC tag according to claim 1, wherein a tapered portion that becomes acute along a direction towards the tip thereof is integrally formed with the main body case.

3. The holder with wireless IC tag according to claim 2, wherein the diameter of the main body case is smaller than the part of the tapered portion with the largest diameter.

4. The holder with wireless IC tag according to claim 1, wherein a small diameter portion is formed at the main body case at the side opposite to the side with the tip of the tapered portion and made to have a diameter smaller than the part of the tapered portion with the largest diameter, and a step portion is formed at the boundary between the tapered portion and the small diameter portion.

5. The holder with wireless IC tag according to claim 1, wherein the largest diameter of the tapered portion is larger than the diameter of the hole formed in the target object of installation.

6. The holder with wireless IC tag according to claim 1, wherein the main body case comprises a pair of components and a connecting component that connects the pair of components so as to allow opening and closing of one component and the other component, wherein the housing portion is formed in at least one of the pair of components and is an indented portion that is sealed when the one component and the other component are closed.

7. A tire having the holder with wireless IC tag in which a wireless IC tag is housed according to claim 1, wherein the holder is inserted in an outer surface of the tire.

8. A tire having the holder with wireless IC tag in which a wireless IC tag is housed according to claim 1, wherein the holder is inserted in an installation hole that is formed in the outer surface of the tire.

9. The tire according to claim 8, wherein the diameter of an entrance side of the installation hole is smaller than that of an inner side of the installation hole.

10. The tire according to claim 7, wherein the holder with wireless IC tag housing the wireless IC tag is inserted into both widthwise direction side surfaces of the tire.

11. The tire according to claim 7, wherein the holder with wireless IC tag is arranged at two or more places on the side surface of the tire with intervals spaced therebetween in the circumferential direction of the tire.

12. The tire according to claim 11, wherein the holders with wireless IC tag are arranged so that, during one rotation of the tire, at least one of the holders with wireless IC tag is positioned less than two meters from the road surface.

13. The tire according to claim 7, wherein at least the color of a portion of the main body case exposed at the tire surface differs from the color of the tire.
